(19) United States
(12) Patent Application Publication
(10) Pub. No.: US 2017/0278205 A1
(43) Pub. Date: Sep. 28, 2017

(54) Digital Rights Management using Organizational Associations

(71) Applicant: Adobe Systems Incorporated, San Jose, CA (US)

(72) Inventor: Arun Anantharaman, Lost Altos Hills, CA (US)

(73) Assignee: Adobe Systems Incorporated, San Jose, CA (US)

(21) Appl. No.: 15/079,788

(22) Filed: Mar. 24, 2016

(51) Int. Cl. G06Q 50/18

(52) U.S. Cl. CPC G06Q 50/184; G06Q 2220/127

(57) ABSTRACT

Digital rights management techniques that leverage organizational associations are described, such as a job title of a user, department in which the user works, and so forth. A digital medium environment is configured to control access to at least on item of content by digital rights management functionality embedded as part of the content. Data is collected that describes organizational traits associated with a request received from the user to access the content. A determination is made from the data using a digital rights management module embedded as part of the content as to whether the organizational traits meet specified traits of an organization behavior of a digital rights management policy enforced by the digital rights management module for the at least one item of the content. Responsive to a determination that the specified traits are met, access is permitted to the least one item of the content by the embedded digital rights management module.

### BACKGROUND

Digital rights management is used to control use of content, e.g., to alter, consume, or distribute content. Current digital rights management techniques are based on qualities that are unique to a particular user. For example, a purchaser of an application from a conventional application store, a song from an online music store, and so on may be given access to the content via a user name and password of an account associated with the user for a corresponding service. Other conventional examples include persistent online authentication, unique content identifiers (e.g., CD keys), digital watermarks, and encryption keys associated with a particular user or user's device.

Each of these conventional techniques, however, is rigid and lacks an ability to address changes in how the content is to be consumed and thus limit usability of the content. Accordingly, this “all-or-nothing” approach to content access may be frustrating to consumers of the content and thus limit desired distribution of the content, and even force the creation of multiple versions of the content and consequently complicate distribution of this content to intended recipients.

### SUMMARY

Digital rights management techniques that leverage organizational associations are described, such as a job title of a user, department in which the user works, and so forth. A digital medium environment is configured to control access to at least on item of content by digital rights management functionality embedded as part of the content. Data is collected that describes organizational traits associated with a request received from the user to access the content. A determination is made from the data using a digital rights management module embedded as part of the content as to whether the organizational traits meet specified traits of an organization behavior of a digital rights management policy enforced by the digital rights management module for the at least one item of the content. Responsive to a determination that the specified traits are met, access is permitted to the least one item of the content by the embedded digital rights management module.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ digital rights management (DRM) and behavioral trait techniques described herein.

FIG. 2 depicts a system in an example implementation of creation of a DRM policy and subsequent content to be consumed by users included in a behavior.

FIG. 3 depicts a system in an example implementation in which digital rights management is utilized to control access to items of content based on a respective user's association with an organization.

FIG. 4 depicts a system in an example implementation in which a client device of FIG. 1 is used to access content and obtain a determination of a likely association of a user with an organization.

FIG. 5 is a flow diagram depicting a procedure in an example implementation in which organizational traits of a behavior are used to control access to content by a digital rights management module that is embedded as part of the content.

FIG. 6 illustrates an example system including various components of an example device that can be implemented as any type of computing device as described and/or utilize with reference to FIGS. 1-6 to implement embodiments of the techniques described herein.

### DETAILED DESCRIPTION

Overview

Conventional digital rights management techniques are rigid and inflexible and thus not able to take into account potentially changing traits of a behavior of a user that is to consume content. For example, conventional techniques typically rely on credentials that are particular to a user such that the credentials uniquely identify that user from each other user. Verification of these credentials is then used to grant access to the content in its entirety in these conventional techniques. This is because conventional credentials do not describe content consumption characteristics of the user.

A user name and password, for instance, may be used to control access to content obtained from an online music store, application store, and so on. Accordingly, the user name and password do not describe behaviors of a population, such as a way in which the population acts or conducts itself toward content. As such, although these conventional techniques may relate to the particular user, these techniques do not address traits of a population behavior that may include the user and thus are not capable of addressing changing traits of the behaviors of the users nor can these conventional techniques adapt to other users.

Digital rights management techniques are described that address traits of a behavior of a user population that is to consume the content. In one or more implementations, traits of a behavior are specified that are incorporated as part of a digital rights management policy for content. Analytics data, for instance, may be collected that describes a user population as a whole. A creator of a DRM policy may then select traits of behaviors for a target population as a subset of this user population to control content consumption by the subset of the user population. As described above, behaviors describe a way in which a user population acts or conducts itself toward content that is relevant to the population as a whole but is not particular to any specific user of that population.

In this way, access to all or portions (i.e., items) of the content may be controlled by a digital rights management module based on contemplated behaviors of consumers of the content, which is embedded as part of the content. For example, a marketer may wish to include an image as part of a marketing campaign for a population segment. The marketer may then specify traits of behaviors of the specific target population (e.g., content consumption characteristics related to age, gender, geographic location included as part of analytics data) to be implemented as part of a digital rights management policy as well as characteristics of content that is to be created.

The characteristics of the content as specified by the marketer are then used by a creative professional to create the content, which is then embedded with a digital rights management module that is configured to implement the digital rights management policy. Thus, in this example a workflow may be supported in which a target population and corresponding policy is first specified through interaction with analytics data and then used as a basis to create content for deployment.

Once deployed, the digital rights management (DRM) module may implement the digital rights management policy to dynamically address traits and changes to the traits of a behavior of users that consume the content. The DRM module, for instance, is configured to control access to different portions of the content based on which traits are met by a user requesting this access. Further, the access may be conditional, such as to permit access to one portion of content if a trait is met (e.g., vice president of an associated business or above) but a different portion of content if the trait is not met. In this way, the marketers may specify how content is to be consumed and address potentially changing tastes and desires of users dynamically as the user's traits change without changing the content itself Accordingly, a single item of content may dynamically change to address changing behaviors of users that are to consume the content which was not possible in conventional techniques, which thus required updates and changes to the content which would then be populated back to the users.

For example, organizational traits may be used to control access to items of the content. This may be used to limit access based on a user's relationship to an organization that may or may not have originated the content. A business, for instance, may generate an employee manual having an embedded DRM module that controls which portions of the manual are made available to users based on their association with the business, e.g., job title, department, and so forth. In this way, a single version of the content may be distributed that is readily and efficiently accessible to relevant portions by the user. Other examples are also contemplated, such as

This may also be performed dynamically by parsing text that describes the association of the user with the organization. For example, the DRM module may be configured to parse data from a social network (e.g., Linkedln®) to determine a user's association with an organization, e.g., a vice president versus an IT professional. The DRM module may then control access to the content based on this determination, such as to tailor an advertisement and text body to be read by the user's to be appropriate to their respective associations, such as to provide detailed functional specs of a computing product to the IT professional versus efficiency and cost considerations to the vice president. In this way, the content may react dynamically to users' associations with an organization in a rich manner, further discussion of which is included in the following sections.

In the description herein, content refers to a variety of different types of content, such as images, video, sound, and so on. Accordingly, characteristics of content to be created may describe a variety of visual and/or audio characteristics, such as objects to be included in an image, general look and feel of the image, types of sounds to be included in sound, locations for capture of video, and so forth. Digital rights management refers to access control techniques that are usable to control access to the content as a whole or particular portions of the content through use of a digital rights management policy, which in the following may be based on traits of a behavior. Traits of behaviors describe a way in which a user population acts or conducts itself toward content that is relevant to the population as a whole but is not particular to any specific user of that population, such as age group, gender, geographic location, profile, business status, group membership, device characteristics. Thus, traits met by a particular user are leveraged by the digital rights management policy to control access to content as a whole or particular portions of the content as further described below.

An example environment is first described that may employ the DRM techniques described herein. Example procedures are then described which may be performed in the example environment as well as other environments. Consequently, performance of the example procedures is not limited to the example environment and the example environment is not limited to performance of the example procedures.

Example Environment

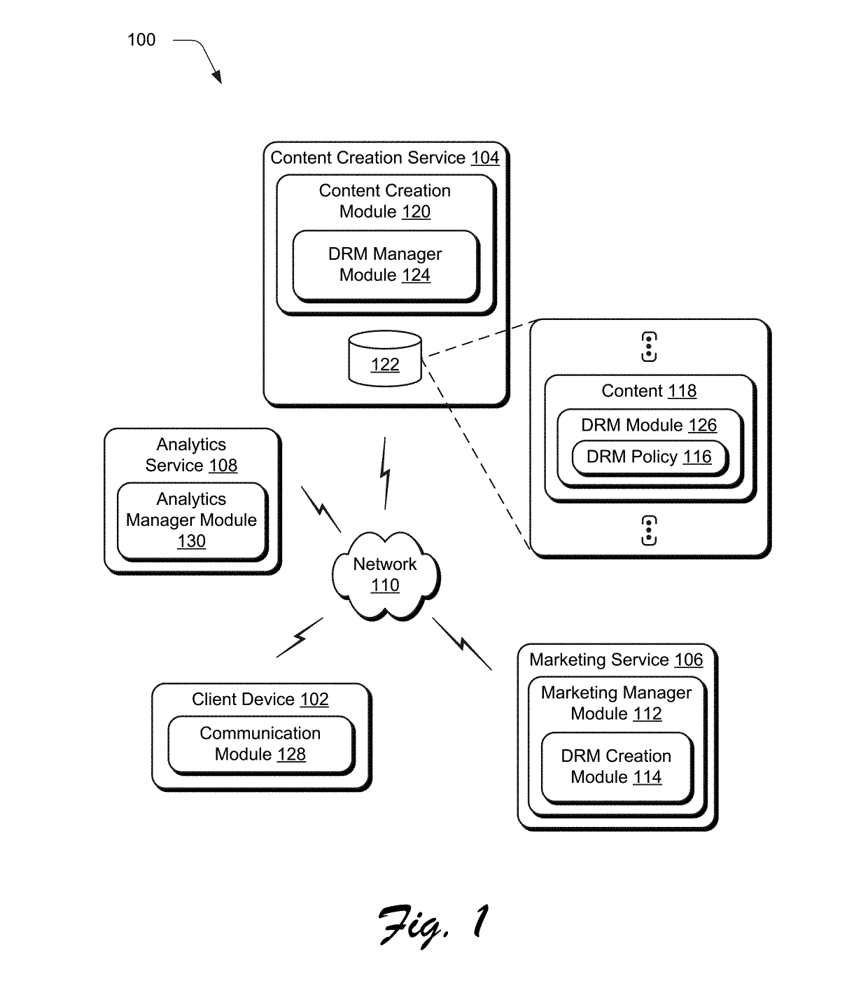

FIG. 1 is an illustration of an environment 100 in an example implementation that is operable to employ digital rights management and behavioral trait techniques described herein. The illustrated environment 100 includes a client device 102, a content creation service 104, a marketing service 106, and an analytics service 108 that are communicatively coupled, one to another, via a network 110. Each of these entities may be configured in a variety of ways using one or more computing devices.

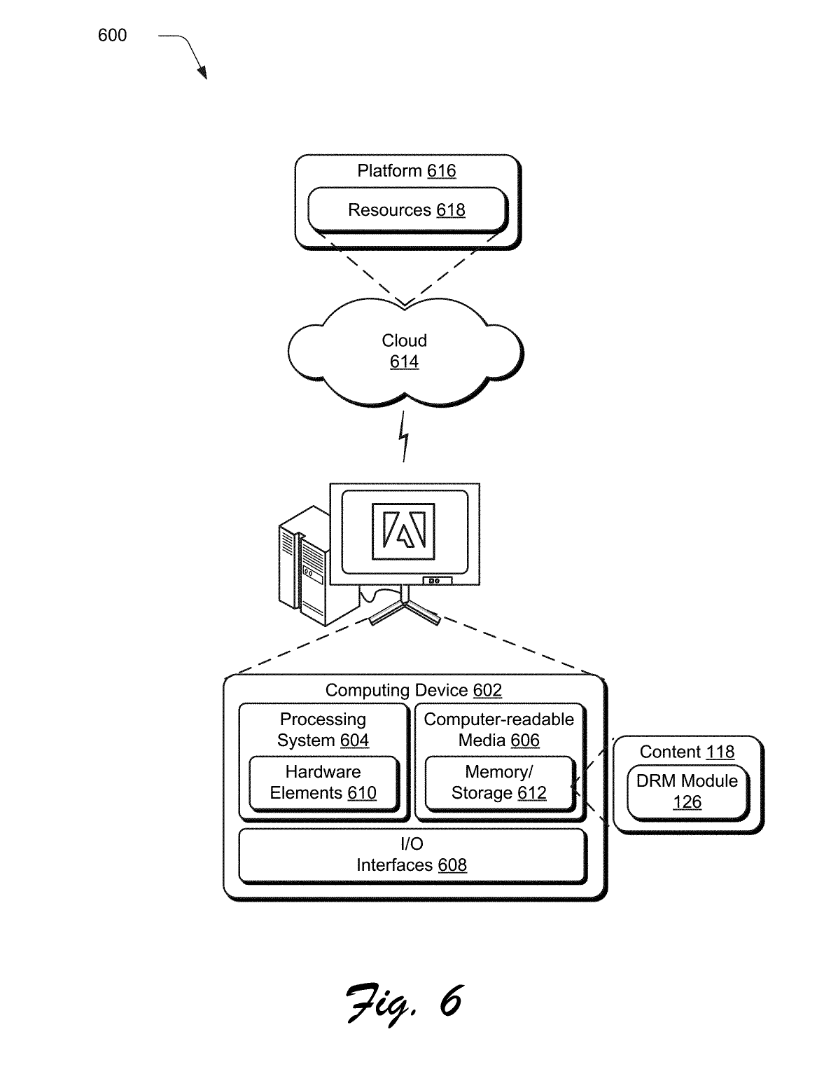

A computing device, for instance, may be configured as a desktop computer, a laptop computer, a mobile device (e.g., assuming a handheld configuration such as a tablet or mobile phone as illustrated), and so forth to implement the client device 102. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” to implement the content creation service 104, the marketing service 106, and the analytics service 108 as further described in relation to FIG. 6.

The marketing service 106 is illustrated as including a marketing manager module 112. The marketing manager module 112 is representative of functionality to support user interaction to create a marketing campaign, track deployment of the marketing campaign, and so forth. A user, for instance, may interact with the marketing manager module 112 to specify a marketing campaign, items of content to be included in the campaign, and one or more behaviors of the campaign. The user may also interact with a DRM creation module 114 that is representative of functionality to specify traits of behaviors to form a DRM policy 116 to be utilized to manage access to content 118. The campaign, for instance, may be configured to control output of different images as a background based on age of users that access the content.

The marketing manager module 112 may employ analytics to generate analytics data (i.e., “big data”) that describes a user population, such as traits of behaviors as described above. Through interaction with the marketing manager module 112, a user may then select traits of behaviors of a target population from this data that are to be met by users to consume corresponding portions of content 118. For example, the marketing manager module 112 may output a user interface via which a user may select traits of behaviors for a desired target population (e.g., age, gender, job title), such as by selecting a check box, keyword input, and so forth. In this way, the user is provided with detailed knowledge of traits of behaviors of a target population and from this knowledge select traits of behaviors to be met to consume particular potions of the content 118, rather than guessing which traits could be met by a target population as performed in conventional techniques which may be prone to error and inefficient.

Data describing the content 118 to be created and the traits specified above as part of creation of the DRM policy 116 through interaction with the DRM creation module 114 is then provided to a content creation service 104 in this example. The content creation service 104 includes a content creation module 120 that is representative of functionality to create content 118, which is illustrated as stored in storage 122. A variety of content 118 may be created, such as webpages, advertisements, media including video and/or audio content, and so forth.

Continuing with the previous example, a user interacts with the content creation module 120 to create content 118 having characteristics as specified by the marketing service 106. As part of this creation, a DRM manager module 124 is used to embed a DRM module 126 as part of the content 118. The DRM manager module 124 is representative of functionality to control implementation of the DRM policy 116 as part of the content 118 during consumption of the content 118, e.g., by a communication module 128 (e.g., browser, web-enabled application) of the client device 102.

The DRM module 126, for instance, may be configured to determine traits of a user that requests access to the content 118 and provide access to portions of the content 118, if any, that correspond to those traits. For example, the DRM policy 116 may specify different backgrounds of an advertisement for different behaviors. Accordingly, the DRM module 126 determines traits of a user requesting access and provides access to corresponding portions of the content 118, e.g., the backgrounds. In this way, the DRM policy 116 as specified by the marketing service 106 in this example serves as a basis for creation of the content 118 and management of access to portions of the content 118. Examples that support additional complications and dynamic responses of DRM control are described in the following.

The DRM module 126 may leverage data obtained from a variety of sources to determine traits associated with a user in order to control access. An example of one such source is illustrated as an analytics service 108 having an analytics manager module 130 that is representative of functionality to collect analytics data. This may include analytics data such as social network posts, webpages visited, items bought and so forth that is exposed via application programming interfaces by websites. This may also include tracking code that is embedded as part of content that exposes data describing usage of the content. Thus, the “big data” collected by the analytics service 108 from third-party sources may describe the user and content usage of the user which may then be used by the DRM module 126 to control interaction with the content 118 as further described below.

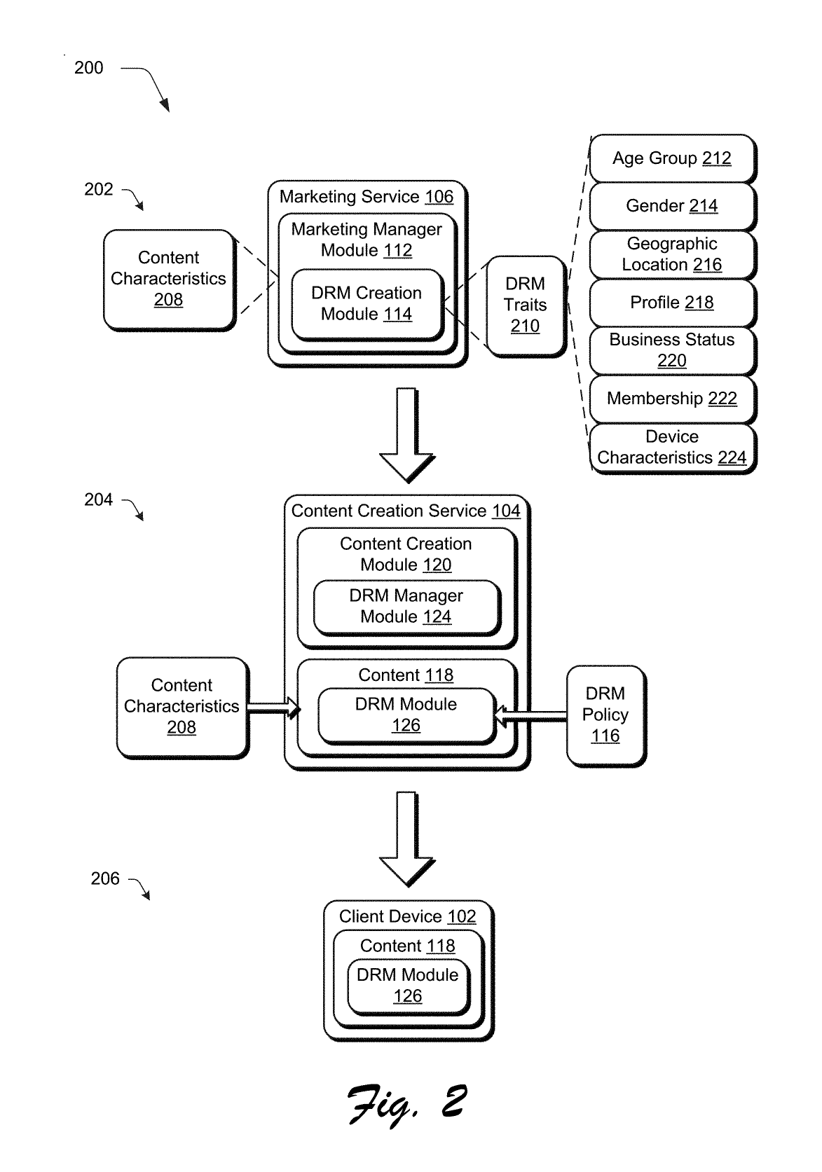

FIG. 2 depicts a system 200 in an example implementation of creation of a DRM policy and subsequent content to be consumed by users included in a target segment. The system 200 is illustrated using first, second, and third stages 202, 204, 206. At the first stage 202, user interaction with a marketing manager module 110 is used to specify content characteristics 208, e.g., for part of a marketing campaign. A variety of different content characteristics 208 may be specified, including type of content such as webpage, printed add, audio such as a jingle or song, video such as an instructional product video or dedicated product advertisement, legal contract. The content is also deliverable in a variety of ways, e.g., streaming or downloaded for local storage and subsequent playback.

The marketing manager module 112 as previously described also includes a DRM creation module 114. The DRM creation module 114 in this instance is representative of functionality to specify digital rights management (DRM) traits 210 of behaviors that are used to create a DRM policy 116 of the content creation service 104. The DRM policy 114 as previously described is configured to control content access by determining which traits of users are satisfied in order to gain access to portions of content. As described above, the DRM traits may be specified in a variety of ways, such as through selection of particular traits collected through analytics by the marketing service 106.

A variety of different DRM traits 210 may be specified, such as traits particular to a behavior but are not unique to individual members having the behavior, e.g., may be satisfied by a plurality of users. Examples of such behavioral traits that are usable to determine potential interaction of a user with content include age group 212 (e.g., particular age or age range), gender 214, geographic location 216 (e.g., based on IP address, city, state, region, country, continent), organizational associations such as profile 218 (e.g., traits included in a social network profile, business title in a business website, educational degrees achieved, particular skills), business status 220 (e.g., whether an associated business is in good standing, business certifications), group membership 222 (e.g., membership to a particular organization), and other traits such as device characteristics 224 of a device being used by the user to gain access (e.g., brand, hardware resources, software resources, display resources), temporal traits (e.g., business hours, time of day, day of week, week of month, year), and so forth.

At the second stage 204, a content creation module 120 of the content creation service 104 is used to create content 118 and a DRM module 126 to control access to the content 118 as specified by a DRM policy 116 created based on the specified DRM traits 210. A creative professional, for instance, may interact with the content creation module 120 of the content creation service 104 to create content 118 as specified by the content characteristics 208 received from the marketing service 106. The marketing service 106, for instance, may specify different images and the content characteristics 208 thereof to be used as alternatives as part of a marketing campaign based on the DRM traits 210. The creative professional may then create content 118 as specified.

The content creation module 116 also includes a DRM manger module 124 that is representative of functionality that is configured to implement the DRM policy 116 through embedding the DRM module 126 as part of the content 118. The DRM module 126, for instance, may be executable to determine DRM traits associated with consumption of the content 118. As described above, these may include DRM traits 210 of a behavior that are not specific to a particular user, including traits of a device used, age group, geographic location, and so forth.

Accordingly, the content 118 having the DRM module 126 may be provided to a client device 102 for consumption as shown at the third stage 206. The DRM module 126 may then be utilized to address differences in traits between users, such as gender 212. The DRM module 126 is also usable to address changes in the user, itself, such as change in age group 212, geographic location 216, business status 220 (e.g., job title) and other organizational associations as further described below, membership 222, and so on as described above. Further, as the DRM module 126 is embedded as part of the content 118 this dynamic consumption may be performed offline without accessing a network, and thus may address limitations of conventional techniques that required access in order to serve different content, such as targeted advertisements as part of webpages that are obtained and not available locally until relevant characteristics of a user are determined.

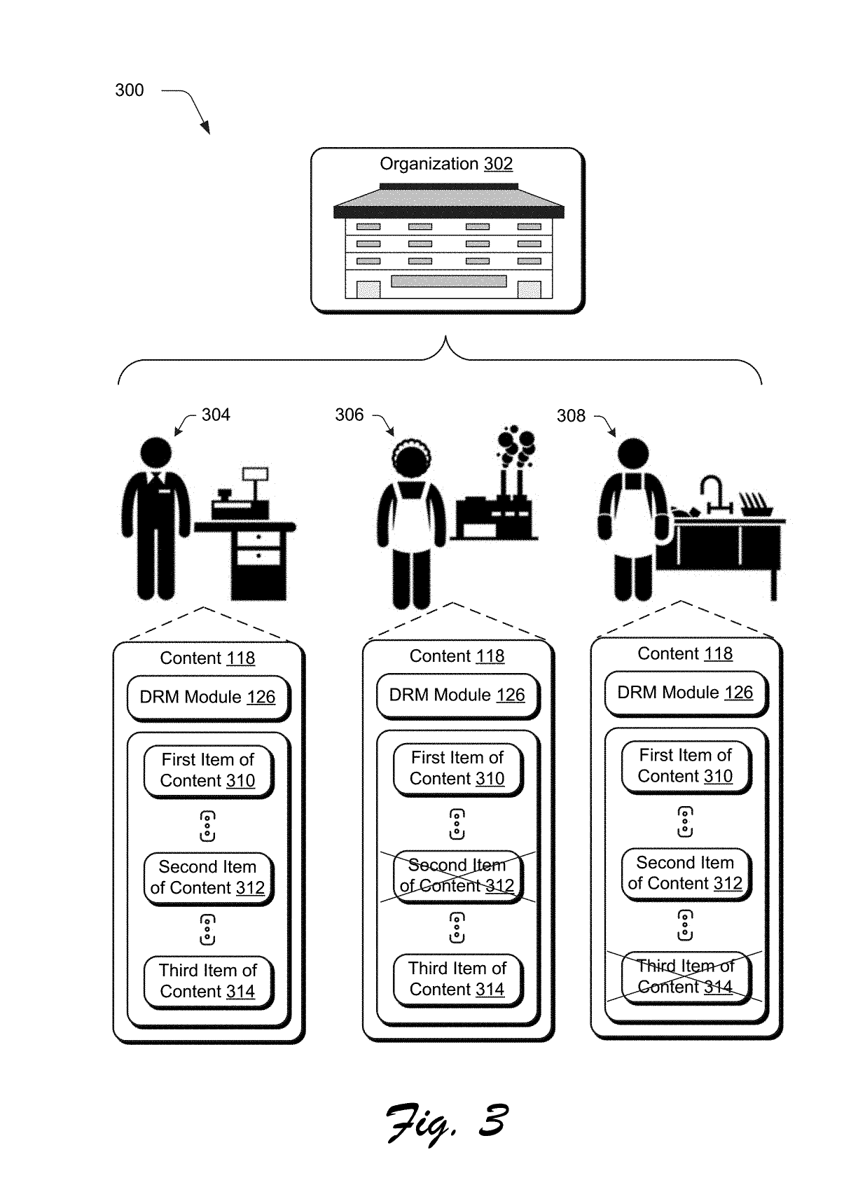

FIG. 3 depicts a system 300 in an example implementation in which digital rights management is utilized to control access to items of content based on a respective user's association with an organization. As previously described, conventional digital rights management techniques are rigid and inflexible and therefore could require multiple versions of the content to address different traits of users to consume the content. However, through embedding a DRM module 126 as part of the content 118, the DRM module 126 may control which items of the content 118 are made available to users, such as based on associations of a user that is to consume the content 118 with an organization 302. In this way, a single piece of content 118 may dynamically address a variety of different associations in an efficient mariner

As illustrated in the example system 300, for instance, first, second, and third users 304, 306, 308 have an association with an organization 302. Organizations 302 may be defined in a variety of ways, such as a business, membership group, social collection whether formal or informal, family, tribe, community, professional network, and so forth. Additionally, a user may have a variety of types of associations with these various types of organizations, such as a member, enrollee, subscriber, team member, tribe member, community member, employee, employer, volunteer, activity director, and so forth. For example, a user's association with a business may include be based on a job title, dep.' ment of the organization 302 in which the user is employed, and so on.

As illustrated in FIG. 3, of instance, the first user 304 has an association with the organization 302 as a vice president in management of the organization 302. The second user 306 has an association with the organization 302 as a factory worker in a manufacturing depathnent. The third user 308 has an association with the organization 302 as a line worker in a cafeteria. Thus, each of the users have different interactions with the organization 302 as part of the associations, which may be addressed by the content 118 dynamically and richly through use of the DRM module 126.

The content 118, for instance, is illustrated as including first, second, and third items of content 308, 310, 312 and the DRM module 126 is configured to control which ones of these items are accessible based on respective user associations with the organization 302. For example, suppose the content 118 in this example is an employee handbook and training manual. The first user 304 as the vice president of the organization 302 is given access by the DRM module 126 to the first, second, and third items of content 308, 310, 312, such as to view and modify these items and the first user 304 has an interest in all parts of the employee handbook and training manual.

The second user 304, with the association as a factory worker, is restricted from access to the second item of content 310, but is permitted access to the first and third items of content 310, 314. The first item of content 310, for instance, may involve generalized human resource information that pertains to all employees of the organization 302 and the third item of content 314 may describe safety procedures within a factory and thus is relevant to the second user 306. The second item of content 312, however, may describe food safety procedures that are not relevant to the second user 306 and thus are restricted from being accessed by the second user 306.

The third user 308, on the other hand, is a line worker at a cafeteria of the organization 302. Thus, the third user 308 is permitted access by the DRM module 126 to the first and second items of content 310, 312 that relate to generalized human resource information and food safety procedures, respectively. The third user 308, however, is restricted from accessing the third item of content 314 that involves safety procedures within the factory as these procedures are not relevant to the third user 308 in this example.

In this way, a single version of content 118 may be distributed to each user having an association with the organization (e.g., employee) and have items of the content 118 that are relevant to that user exposed and those items that are not relevant restricted from access. Thus, efficiency of users in accessing these items may be increased by the DRM module 126. Further, this may be combined with other traits, such as to limit access of all three users to within a geographical location of the factory.

In one or more implementations, an alternative item of content is made accessible instead that otherwise would not be output if the access to the second item of content 312 was permitted, such as to include a version of the second item of content 312 that does not included information to be protected. The DRM module 126 may determine the associations of the users with the organization 302 in a variety of ways, examples of which are included in the following description and corresponding figure.

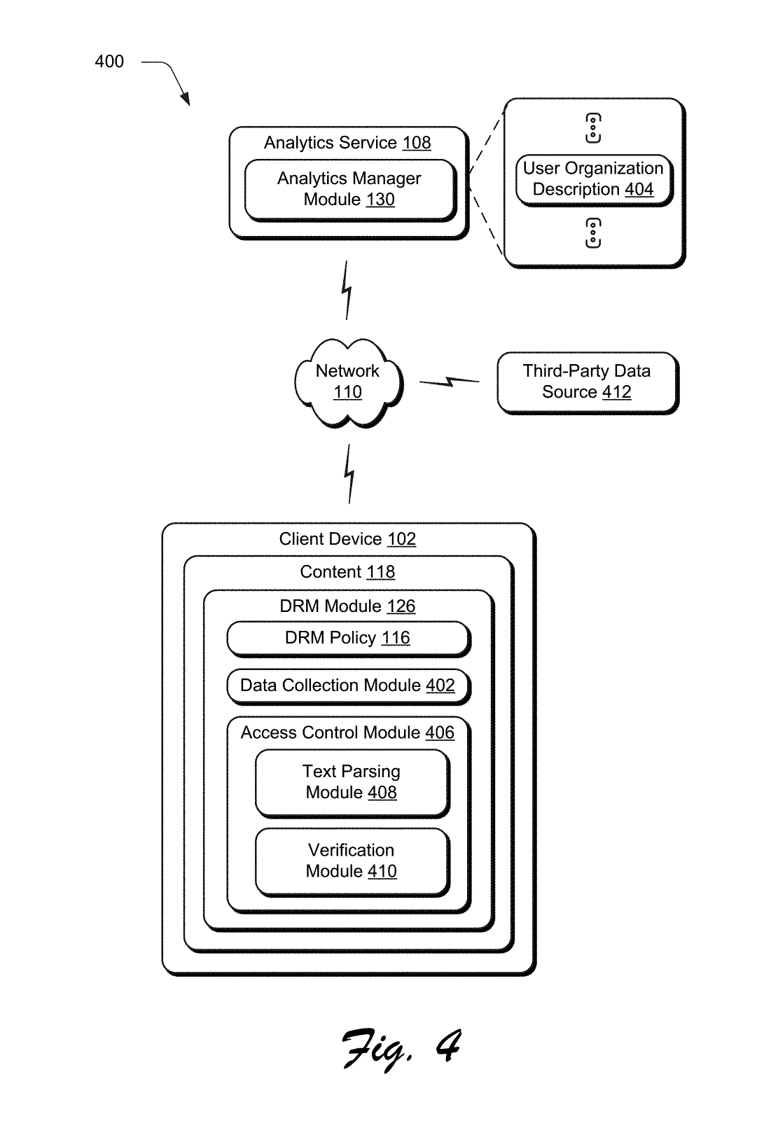

FIG. 4 depicts a system 400 in an example implementation in which the client device 102 of FIG. 1 is used to access the content 118 and obtain a determination of a likely association of a user with an organization. The client device 102 includes content 118 have an embedded DRM module 126 to enforce a DRM policy 116 that is based at least in part of an organization association behavior as previously described.

The client device 102 may obtain data describing this association in a variety of ways. In one example, the DRM module 126 includes a data collection module 402 that is representative of functionality to obtain data describing this association. A user, for instance, may input this data manually through interaction with a user interface of the client device 102. In another instance, a user may login the client device 102 for access to a domain in a network, e.g., as part of the organization 302. This information may be used by the DRM module 126 without further manual entry by the user to determine an association of the user with the organization 302 (e.g., job title, department, and so forth) to control access to the content 118 as previously described.

The data collection module 402 may also obtain data describing this association from sources that are available remotely via the network 110. An analytics service 108, for instance, may employ an analytics manager module 130 to process data to obtain a user organization description 404 that is usable to determine this association. The analytics service 108, for instance, may access an application programming interface exposed by the organization to be accessible via the network 110 to obtain data describing this association, e.g., a user's name and job title.

In another example, the analytics manager module 130 is configured to obtain a user organization description 404 from third-party sources that potentially describe the association of the user with the organization 302. The analytics service 108, may collect posts managed by a social network service, such as Facebook®, Twitter®, Linkedln®, and so forth. The posts, for instance, may include text entered by a user that describes the user's association with the organization 302, e.g., job title, company the user works for, social groups, and so on. Other data may also be collected, such as from newspaper articles (e.g., “John now hired as VP at Business”) or other sources that are not originated by the user. The data collection module 402 may then provide this data to an access control module 406 and use a text parsing module 408 to parse this user organization description 404 automatically and without user intervention to determine the association of the user with the organization 302. In this way, the DRM module 126 may employ data from a variety of sources to determine a user's association with an organization 302 that is to be used to control content 118 access.

The availability of these various ways in which to determine the association may support a variety of functionality. For example, these techniques may be utilized to verify each other, such as to verify that a likely association of a user determined using a social network service with an association determined from a newspaper. A user, for instance, include a job title on a social network service of “engineer at Business” from the analytics service 108 but a recent newspaper article from a third-party data source 412 may indicate that the user is promoted to “senior engineer at Business.” Thus, a verification module 410 of the access control module 406 may use these separate sources to determine a most likely and up-to-date association of the user with the organization 302. A variety of other examples are also contemplated, description of which is included in the following section.

Example Procedures

The following discussion describes digital rights management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

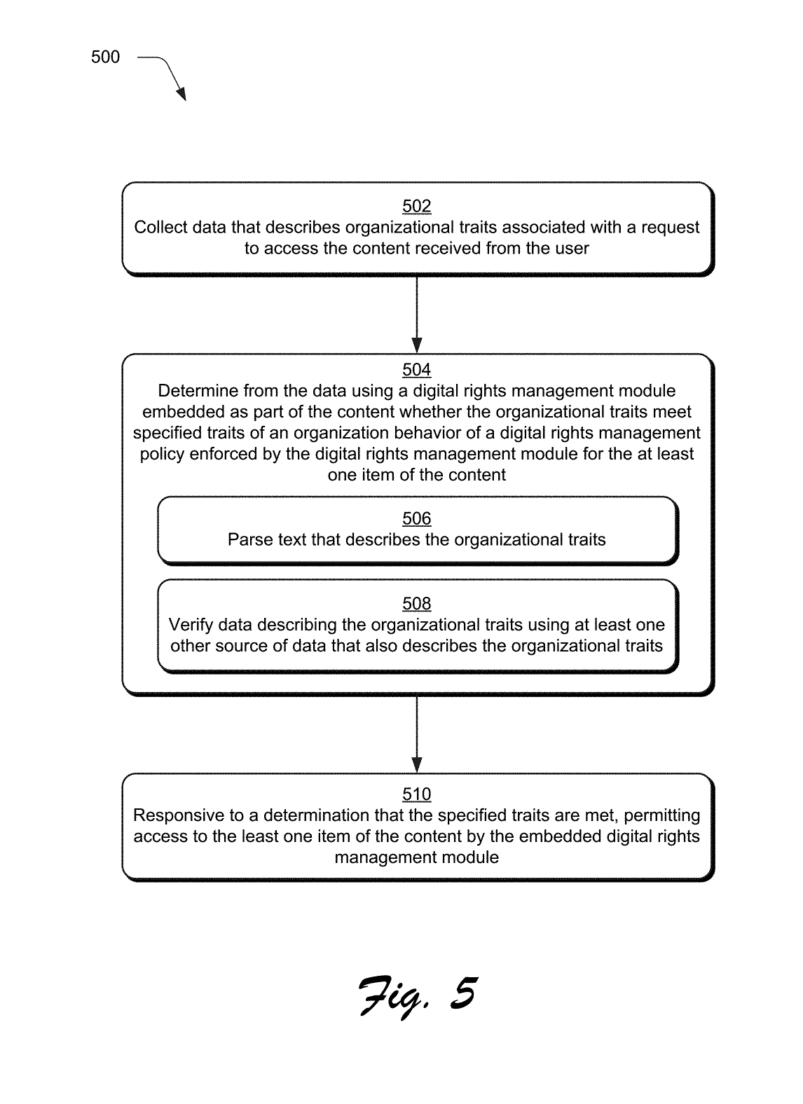

FIG. 5 depicts a procedure 500 in an example implementation in which organizational traits of a behavior are used to control access to content by a digital rights management module that is embedded as part of the content. Data is collected describing organization traits associated with a request received from the user to access the content (block 502), such as a user's role within a business, depailiiient, and so forth. This data may be collected from a variety of sources, such as manually entered by a user, obtained via an application programming interface exposed by the organization 302, and so on. For example, the content 118 may be created to describe products or services. This content 118, however, is to be consumed by users based on their associations with respective companies other than an originator of the products or services.

Accordingly, a determination is made from the data using a digital rights management module embedded as part of the content as to whether the organizational traits meet specified traits of an organization behavior of a digital rights management policy enforced by the digital rights management module for the at least one item of the content (block 504). As the data may be obtained from a variety of different sources, such as an application programming interface of a website of the organization, parsed from social media, and so forth, this determination may be made in a variety of ways. For example, text may be parsed that describes the organization traits (block 506). The DRM module 126, for instance, may access a user's profile one a social network site to obtain data that describes a user's association with a respective organization. In another example, the content 118 may be configured as a reply email that leverages a user's title in a signature line, to which, the email is replying.

This data may also be verified with data collected from other sources to promote accuracy (block 508), such as to verify social network data with a website user biography. Responsive to a determination that the specified traits are met, access is permitted to the least one item of the content by the embedded digital rights management module (block 510). In not met, access is blocked, which may include output of an alternate item of content in its stead. In this way, a single version of content 118 may dynamically address a variety of different organizational associations in an efficient manner and thus does not require the generation and dissemination of multiple versions of the content as was required in conventional techniques.

Example System and Device

FIG. 6 illustrates an example system generally at 600 that includes an example computing device 602 that is representative of one or more computing systems and/or devices that may implement the various techniques described herein. This is illustrated through inclusion of the content 118 and DRM module 126. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control access to at least one item of content by digital rights management functionality embedded as part of the content, a method implemented by a computing device, the method comprising:
collecting data, by the computing device, that describes organizational traits associated with a request received from the user to access the content;
determining from the data using a digital rights management module embedded as part of the content whether the organizational traits meet specified traits of an organization behavior of a digital rights management policy enforced by the digital rights management module for the at least one item of the content; and
responsive to a determination that the specified traits are met, permitting access to the least one item of the content by the embedded digital rights management module.

2. The method as described in claim 1, wherein the collecting of the data describing the organizational traits is performed at least in part by accessing an analytics service by the computing device over a network.

3. The method as described in claim 2, wherein the data is collected by the analytics service from one or more other service providers via the network, the data associated with the user that originated the request.

4. The method as described in claim 3, wherein the one or more other service providers include at least one social network service.

5. The method as described in claim 3, wherein the determining by the digital rights management module includes verifying data describing the organizational traits using at least one other source of data that also describes the organizational traits.

6. The method as described in claim 1, further comprising responsive to a determination that the specified traits are not met, restricting access to the least one item of the content and permitting access to another item of content in which the access to the other item of content is not permitted if the determination is made that the specified traits are met.

7. The method as described in claim 1, wherein the organizational traits describe the user's role at an organization that originated the content.

8. The method as described in claim 6, wherein the organization is a business and the user's role is defined using a job title or department at the business.

9. The method as described in claim 6, wherein the determining includes parsing text that describes the organizational traits, the data obtained by the computing device via a network via an application programming interface of an organization that originated the content.

10. The method as described in claim 1, further comprising responsive to a subsequent determination that the organization traits associated with the user no longer meet the specified traits, blocking access to the at least one item of content through execution of the embedded digital rights management module by the at least one computing device.

11. In a digital medium environment to control access to at least one item of content by digital rights management functionality embedded as part of the content, a system comprising:
a digital rights management module implemented at least partially in hardware of a computing device, the digital rights management module embedded as part of the content and configured to control access to the at least one item of content, the digital rights management module including:
a data collection module implemented at least partially in the hardware of the computing device and configured to collect data that describes organizational traits associated with a request to access the content received from the user; and
an access control module implemented at least partially in the hardware of the computing device and configured to control access to the at least one item of content based on a determination from the data as to whether the organizational traits meet specified traits of an organization behavior of a digital rights management policy.

12. The system as described in claim 11, wherein the collecting of the data describing the organizational traits is performed by the data collection module at least in part by accessing an analytics service by the computing device over a network.

13. The system as described in claim 12, wherein the data is collected by the analytics service from one or more other service providers via the network, the data associated with the user that originated the request.

14. The system as described in claim 11, wherein the access control module is configured to verify the data describing the organizational traits using at least one other source of data that also describes the organizational traits.

15. The system as described in claim 11, wherein the organizational traits describe the user's role at an organization that originated the content.

16. The system as described in claim 15, wherein the organization is a business and the user's role is a job title or department at the business.

17. The system as described in claim 11, wherein the access control module is configured to parse text that describes the organizational traits, the data obtained by the computing device via a network via a website of the organization.

18. In a digital medium environment to control access to at least one item of content by digital rights management functionality embedded as part of the content, a system comprising:
a digital rights management module implemented at least partially in hardware of a computing device, the digital rights management module embedded as part of the content and configured to control access to the at least one item of content, the digital rights management module including:
a data collection module implemented at least partially in the hardware of the computing device and configured to:
determine a user identifier used to access a domain in a network of an organization by a user; and
collect data that describes organizational traits of the user with respect to the organization; and
an access control module implemented at least partially in the hardware of the computing device and configured to control access to the at least one item of content based on a determination from the data as to whether the organizational traits meet specified traits of an organization behavior of a digital rights management policy.

19. The system as described in claim 18, wherein the access control module is configured to parse text that describes the organizational traits, the data obtained by the computing device via a network via a website of the organization.

20. The system as described in claim 18, wherein the access control module is configured to collect the data automatically and without user intervention by the user.
